(19) United States
(12) Patent Application Publication
(10) Pub. No.: US 2024/0416820 A1
(43) Pub. Date: Dec. 19, 2024

(54) TRUCK MIXER

(71) Applicant: ZF Friedrichshafen AG, Friedrichshafen (DE)

(72) Inventor: Thomas RIEGER, Ortenburg (DE)

(21) Appl. No.: 18/731,380

(22) Filed: Jun. 3, 2024

(30) Foreign Application Priority Data
Jun. 13, 2023 (DE) 10 2023 205 460.4

(51) Int. Cl. B60P 3/16; B28C 5/42; B60L 1/00

(52) U.S. Cl. CPC B60P 3/16; B28C 5/421; B28C 5/422; B28C 5/4268; B60L 1/003

(57) ABSTRACT

A truck mixer including a mixing device, wherein the mixing device includes a rotatable mixing drum, an electric drive which is configured for controlling a rotational speed of the mixing drum, and a brake. The brake can be adjusted between a released state, in which rotation of the mixing drum is released, and a stopping state, in which the mixing drum is locked. The truck mixer is configured to lock the mixing drum automatically with the brake in an event of a fault of the electric drive.

### CROSS REFERENCE TO RELATED APPLICATIONS

This application claims benefit to German Patent Application No. DE 10 2023 205 460.4, filed on Jun. 13, 2023, which is hereby incorporated by reference herein.

### FIELD

The present invention relates to a truck mixer.

### BACKGROUND

Truck mixers are for example designed as mobile concrete mixers which can transport fresh concrete to a construction site. For this purpose, truck mixers have a rotatable mixing drum which is arranged at a rear end of the truck mixer for example. The mixing drum is rotated during transport in order to mix the concrete thoroughly and to avoid or to reduce curing or quality reduction during transport. Usually, the mixing drum is driven hydraulically in this case. However, a hydraulic drive system for the mixing drum is heavy, expensive and maintenance-intensive.

Also, in the case of truck mixers, there is the desire to provide electric traction drives instead of internal combustion engines, as is also the case in other trucks. Likewise, a replacement of the hydraulic drive system for the mixing drum by an electric drive system may be desired. In this case however, there may be problems with regard to operational reliability. For example, in the event of a failure of control electronics, the mixing drum may rotate with too high a rotational speed or not come to a stop at the right time, as a result of which potentially undesired driving situations or other operating situations may occur.

### SUMMARY

In an embodiment, the present disclosure provides a truck mixer comprising a mixing device, wherein the mixing device includes a rotatable mixing drum, an electric drive which is configured for controlling a rotational speed of the mixing drum, and a brake. The brake can be adjusted between a released state, in which rotation of the mixing drum is released, and a stopping state, in which the mixing drum is locked. The truck mixer is configured to lock the mixing drum automatically with the brake in an event of a fault of the electric drive.

### BRIEF DESCRIPTION OF THE DRAWINGS

Subject matter of the present disclosure will be described in even greater detail below based on the exemplary FIGURES. All features described and/or illustrated herein can be used alone or combined in different combinations. The features and advantages of various embodiments will become apparent by reading the following detailed description with reference to the attached drawings, which illustrate the following:

FIG. 1 schematically shows a mixing device of a truck mixer.

### DETAILED DESCRIPTION

A first aspect relates to a truck mixer having a mixing device. A truck mixer can for example be designed as a mobile concrete mixer. A truck mixer can for example be based on a truck which has the mixing device at its rear end. The truck mixer can for example be designed for transporting fresh concrete to a construction site. The truck mixer can however also be designed for transporting other substances for example, such as other construction materials which must be mixed during transport. A truck mixer can have a traction drive. The traction drive can for example have a traction motor for providing a tractive force for the truck mixer. The traction drive can have a transmission, by means of which the tractive force can be transmitted to an output of the truck mixer, such as respective driven axles for example. The truck mixer can for example be designed as a three-axle or four-axle truck. The truck mixer can also be designed as a semitrailer. The truck mixer can in this case not have a traction drive of its own for example. The truck mixer can for example have a coupling device which is designed to connect the truck mixer to a tractor unit. The tractor unit can provide electrical energy for operating the truck mixer via the coupling device. The truck mixer can also be designed as a tractor-unit combination, wherein the truck mixer then has a tractor unit and a trailer having the mixing device.

The mixing device can have a rotatable mixing drum. The mixing drum can for example be mounted in a rotatable manner by means of respective bearings on a frame of the truck mixer. The mixing device can for example have an upper feeding funnel, by means of which fresh concrete can be poured into the mixing drum. During the transport, the mixing drum can for example rotate in one direction in order to mix the transported goods, such as the fresh concrete, thoroughly during the transport. A spiral paddle can be arranged in the mixing drum, which additionally mixes the fresh concrete thoroughly during the rotation of the mixing drum. By reversal of the direction of rotation, the fresh concrete can be conveyed out of the mixing drum, for example by means of the spiral paddle in the manner of a screw conveyor. The mixing device can for example have a chute, by means of which the transported goods can be discharged at the destination. However, different elements can also be provided for outputting the fresh concrete, such as a plastic pipe for example. During output, the concrete can additionally be made more fluid using a superplasticizer. Alternatively, the output can also take place by means of a truck mixer pump instead of by means of the mixing device.

The mixing device has an electric drive unit which is designed for controlling a rotational speed of the mixing drum. The drive unit can for example specify a stop, a start of a rotation of the mixing drum and, during rotation of the mixing drum, the rotational speed of the mixing drum. For this, the electric drive unit has an electric drive motor for example, the rotational speed of which can be set by a predetermined energization. The electric drive motor can for example be designed as a synchronous motor or asynchronous motor. A shaft of the drive motor can be connected to the mixing drum by means of a transmission of the electric drive unit. The mixing device can for example have a power supply for the electric drive unit. The supply of power can for example take place by means of a high-voltage battery which also supplies an electric traction drive of the truck mixer with electrical energy. The supply of power can however also take place by means of a generator which is driven by a conventional internal combustion engine of the truck mixer. The electric drive motor can for example likewise be used to brake and alternatively or additionally lock the mixing drum. In the event of failure of electronics or a power supply, a safe stop of the mixing drum can then no longer be guaranteed however.

The mixing device has a brake device. The brake device can be adjusted between a released state, in which the rotation of the mixing drum is released, and a stopping state, in which the mixing drum is locked. For this, the brake device can for example have a multiple-disk clutch, by means of which the mixing drum can be connected to a chassis of the truck mixer in a rotationally fixed manner. To this end, the brake device can be designed to end a rotation of the mixing drum, for example if the electric drive unit fails or has a fault.

The truck mixer is designed to lock the mixing drum automatically by means of the brake device in the event of a fault of the electric drive unit. A fault of the drive unit can for example be a failure of rotational speed control for the mixing drum. A fault of the drive unit can however also be a failure of electrical energy supply for driving the electric drive motor and therefore the mixing drum, for example. A hydraulic drive unit brakes the mixing drum if it fails, owing to its operating principle, and holds the mixing drum in position. If a hydraulic drive unit for the mixing drum is replaced by an electric drive unit, this property of the drive unit is, in contrast to a hydraulic drive unit, no longer inherently present. Therefore, the brake device is provided in order to be able to guarantee safe operation of the truck mixer.

In one embodiment of the truck mixer, it is provided that the electric drive unit has an electric drive motor and a power supply device. The power supply device can have an electrical energy storage device, such as a battery. The power supply device can also have a generator, by means of which mechanical energy can be converted into electrical energy. The power supply device can for example be provided exclusively for the electric drive unit. The power supply device can optionally also supply a traction drive of the truck mixer with electric power. The power supply device can be designed to additionally supply the brake device with electric power for its activation. The brake device can be designed as an electric brake device which, in a de-energized state, automatically changes to its stopping state. The brake device can therefore be preloaded in its stopping state by means of a spring or a magnet for example. An electric brake device can for example be activated by applying a voltage or by means of supplying electric power. In order to set the brake device to its released state, the brake device must be energized for example. As a result, a multiple-disk clutch can for example be adjusted to an open state by an electromagnet, counter to the spring force of the spring. By means of the supply with electric power, the brake device can for example be held in its released state and then return to the stopping state automatically if the supply of power is lost.

The power supply device can be designed to supply electric power to the drive motor for rotating the mixing drum and to the brake device for keeping the brake device in its released state. In the event of a power failure, the brake device can therefore be adjusted to its stopping state automatically. Therefore if, for example, the supply of power to the brake device by the power supply device is interrupted, the mixing drum is automatically braked to a stop and then held in position. As a result, an automatic securing in place of the mixing drum can be provided. In addition, a locking of the mixing drum can be guaranteed if an energy storage device of the power supply device is completely empty. Also, when the truck mixer or at least the power supply device is switched off, locking of the mixing drum can thus be achieved automatically.

In an embodiment of the truck mixer, it is provided that the electric drive unit has an inverter. The inverter can be designed as power electronics of the electric drive unit. The inverter can be designed to detect a fault case in the electric drive unit and, in the case of a detected fault case, to set the brake device to the stopping state. By means of the inverter, it is therefore possible for example to actively control an adjustment of the brake device between its two states. The inverter can monitor the electric drive unit and adjust the brake device depending on its state. For example, the inverter can also automatically adjust the brake device to its released state if there is a desire to start rotation of the mixing drum. The inverter can have respective sensors or be connected to respective sensors, by means of which state variables of the electric drive unit or even the mixing device as a whole can be detected. The inverter can evaluate respective sensor signals and detect the fault case as a result. Respective fault cases can be specified at the factory for example. For example, respective threshold values can be defined for respective state variables, which must not be exceeded by the mixing device. The mixing drum can then automatically be locked if these threshold values are exceeded.

In an embodiment of the truck mixer, it is provided that the inverter is designed to monitor at least one state variable of the electric drive unit and to compare it with a desired state in order to detect the fault case. A desired state can for example correspond to a predetermined state variable. For example, a desired state can have a predetermined instantaneous rotational speed of the mixing drum. Alternatively or additionally, a desired state can have predetermined threshold values for the state variables. For example, a desired state can have a maximum instantaneous rotational speed of the mixing drum. The desired state can for example be predetermined by a current operating mode and alternatively or additionally an instantaneous desired rotational speed of the mixing drum.

The state variable can for example be an operating temperature. An operating temperature can be an instantaneous temperature of an element of the truck mixer. For example, the operating temperature can be a temperature of windings of the electric drive motor of the electric drive unit. As a result, overheating can be avoided or in the event of overheating, the mixing drum can be locked in order to avoid damage. The state variable can for example be a rotational speed. The rotational speed can for example be an instantaneous rotational speed of the mixing drum and alternatively or additionally an instantaneous rotational speed of a shaft of the electric drive motor of the electric drive unit. As a result, in the event of a fault of the control of the rotational speed, damage can be avoided by locking the mixing drum. The state variable can for example be a direction of rotation. The direction of rotation can for example be a current direction of rotation of the mixing drum and alternatively or additionally a current direction of rotation of a shaft of the electric drive motor of the electric drive unit. As a result, an undesired emptying of the mixing drum can reliably be prevented for example. It is also possible for a plurality or all of these state variables to be monitored by the inverter and compared with the desired state, in order to detect the fault case. The desired state can for example be stored in tabular form in a data memory of the inverter. The desired state can also be determined by the inverter depending on a current operating state of the truck mixer and a desired behavior of the mixing device. The inverter can for example have a microprocessor for this. The desired state can have respective desired values and alternatively or additionally threshold values for some or all of the monitored state variables.

The inverter can also be designed to switch off the electric drive unit in the event of a detected fault case. For this, a fuse can for example be opened in order to interrupt a power supply of the electric drive motor. For example, a rotational speed of zero can be predetermined for the mixing drum by the inverter in the event of a detected fault case. For this, a corresponding control signal can for example be output to the mixing device, for example the electric drive unit thereof.

In an embodiment of the truck mixer, it is provided that the electric drive unit has a first electrical energy source, which is designed for supplying the brake device with electric power, and a second electrical energy source, which is designed for supplying the inverter for detecting fault cases. The electric drive unit can thus have separate energy sources for the brake device and the monitoring by the inverter. As a result, the inverter can be operated further in the event of a failure of the first energy source, for example in order to control the electric drive motor of the electric drive unit of the mixing device, for example in order to switch off the electric drive motor. The inverter is therefore further supplied with energy if the first electrical energy source fails. As a result, the brake device can then also optionally be controlled further by the inverter. In addition, energy sources having different voltages, capacitances and alternatively or additionally powers can thus be provided. The first electrical energy source can for example be designed as a high-voltage battery. The first electrical energy source can for example be designed as a traction battery for a traction drive of the truck mixer. The second electrical energy source can for example be designed as a low-voltage battery. The second electrical energy source can for example represent the electrical energy source for a vehicle electrical system. The first electrical energy source and alternatively or additionally the second electrical energy source can be designed to supply the drive motor of the electric drive unit with electric power.

In an embodiment of the truck mixer, it is provided that the truck mixer has an electric traction drive. For example, the truck mixer can be free of an internal combustion engine. A tractive force of the truck mixer can for example be provided purely electrically. The electric traction drive can for example have an electric traction motor which converts electrical energy into mechanical energy. Optionally, the electric traction motor can also be designed for recuperation. Due to the provision of the electric traction drive, the truck mixer can be electrified completely. In addition, respective electrical energy sources can thus be used together for supplying the mixing device and the traction drive. As a result, the truck mixer can be particularly inexpensive and environmentally friendly. Furthermore, it is thus possible to dispense with a hydraulic system in the truck mixer completely. As a result, respective components of the truck mixer can be arranged in the installation space thereof in a particularly simple and flexible manner. Optionally, the truck mixer also has electric steering. For example, the truck mixer can have respective electric motors, using which a steerable axle of the truck mixer is rotated or by means of which such a rotation is supported.

In an embodiment of the truck mixer, it is provided that the first electrical energy source is also designed for supplying the electric traction drive with electric power. If the traction drive fails owing to a failure of the first electrical energy source, then the mixing drum can also be locked in a simple manner. The first electrical energy source is designed as a traction battery in this case for example.

In an embodiment of the truck mixer, it is provided that the first electrical energy source is connected to the brake device by means of a DC-to-DC voltage converter. As a result, lower voltage can easily be provided for operating the brake device and in particular for keeping the brake device in its released state. Thus, it is possible to dispense with a separate energy source from the traction drive for example. Power consumption of the brake device can thus be kept low. At the same time, the first electrical energy source can thus furthermore provide high currents and alternatively or additionally also high voltage for supplying the traction drive with electrical energy.

In an embodiment of the truck mixer, it is provided that the inverter is designed to monitor a state of the brake device and to switch off the electric drive motor if the brake device has changed to the stopping state. Thus, for example it is possible to avoid the electric drive motor continuing to operate against a brake device in the stopping state. For example, a fault case can also occur at the brake device, which can thus be detected, wherein further damage can then be avoided by switching off the drive unit.

### DETAILED DESCRIPTION OF EMBODIMENTS

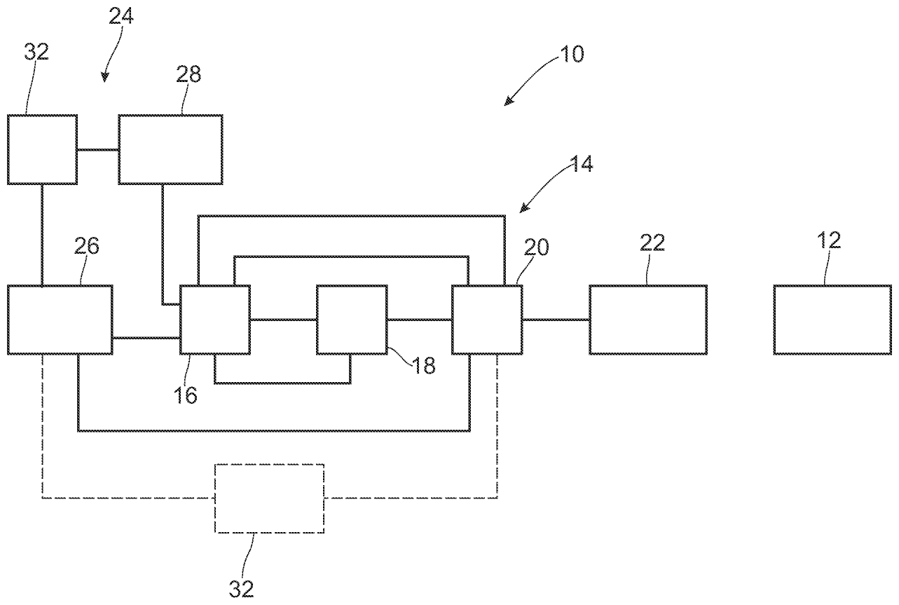

FIG. 1 schematically shows a mixing device 10 of a truck mixer. The mixing device 10 has a mixing drum 12 which is driven by an electric drive unit 14. For this, the electric drive unit 14 has an inverter 16 and an electric drive motor 18. The inverter 16 controls a power supply of the electric drive motor 18, using which a rotational speed of the mixing drum 12 can be controlled.

The electric drive motor 18 is mechanically connected to a transmission 22 of the electric drive unit 14 via a brake device 20. The transmission 22 provides a transmission ratio between the electric drive motor 18 and the mixing drum 12. The brake device 20 can be adjusted between a released state, in which the rotation of the mixing drum 12 is released, and a stopping state, in which the mixing drum 12 is locked. The brake device 20 is designed as an electric brake device 20 which, in a de-energized state, automatically changes to its stopping state. Therefore, in the embodiment shown, a spring preloads the brake device 20 in its stopping state. The inverter 16 controls the brake device 20 for adjustment to the released state as long as rotation of the mixing drum 12 is requested and assuming that the brake device 20 is energized and therefore in its released state.

The truck mixer is designed to lock the mixing drum 12 automatically by means of the brake device 20 in the event of a fault of the drive unit 14. There are several possibilities for this. The electric drive unit 14 has a power supply device 24. The power supply device 24 is designed to supply electric power to the drive motor 18 for rotating the mixing drum 12 and to the brake device 20 for keeping the brake device in its released state. To this end, the power supply device 24 has a first electrical energy source 26 and a second electrical energy source 28, which are connected to one another via a DC-to-DC voltage converter 30. The first electrical energy source 26 is designed as a traction battery having a high-voltage battery, by means of which an electric traction drive of the truck mixer can be supplied with electric power for its operation. In addition, the first electrical energy source 26 supplies the brake device 20 with electric power. This supply with power can take place directly or, in an alternative that is illustrated dashed, in a different embodiment via a further DC-to-DC voltage converter 32 which connects the brake device 20 to the first energy source 26. The second electrical energy source 28 is designed as a low-voltage battery which provides an on-board voltage of 24 volts. The inverter 16 is electrically connected both to the first energy source 26 and the second energy source 28. Thus, the inverter 16, as power electronics, can control an output of electric power by the first energy source 26, in the embodiment shown also for operating the electric drive motor 18 of the mixing device 10.

In the case of a first fault, the electric power supply of the brake device 20 by the first energy source 26 fails, for example owing to a defect in the traction drive of the truck mixer. The brake device 20 can thus no longer be kept in the released state and the spring presses the brake device 20 into its stopping state. The mixing drum 12 is thus braked and ultimately locked.

In addition, the inverter 16 is designed to detect a fault case in the electric drive unit 14 and, in the case of a detected fault case, to set the brake device 20 to the stopping state. Therefore, the inverter 16 is designed to monitor an operating temperature of the electric drive motor 18, a rotational speed of the electric drive motor 18 and a direction of rotation of the electric drive motor 18 as state variables of the electric drive unit 14. These monitored state variables are compared with a desired state which for example has respective limits of a deviation from the currently desired state variables. Therefore, the fault case can be detected and as a reaction to it, the mixing drum 12 can be locked by controlling and thus setting the brake device 20 to the stopping state by means of the inverter 16.

In addition, the inverter 16 is also designed to monitor a state of the brake device 20. If the inverter 16 detects that the brake device 20 is in an undesired state, the inverter 16 can switch off the electric drive motor 18 for the mixing drum 12. In the embodiment shown, the inverter 16 switches the electric drive motor 18 off if the brake device 20 changes to the stopping state, for example owing to the failure of the electric power supply thereof.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

10 Mixing device
12 Mixing drum
14 Electric drive unit
16 Inverter
18 Electric drive motor
20 Brake device
22 Transmission
24 Power supply device
26 First electrical energy source
28 Second electrical energy source
30 DC-to-DC voltage converter
32 Further DC-to-DC voltage converter

1. A truck mixer comprising a mixing device, wherein the mixing device includes:
a rotatable mixing drum,
an electric drive which is configured for controlling a rotational speed of the mixing drum, and
a brake,
wherein the brake can be adjusted between a released state, in which rotation of the mixing drum is released, and a stopping state, in which the mixing drum is locked, and
wherein the truck mixer is configured to lock the mixing drum automatically with the brake in an event of a fault of the electric drive.

2. The truck mixer as claimed in claim 1, wherein the electric drive has an electric drive motor and a power supply,
wherein the brake is configured as an electric brake which, in a de-energized state, automatically changes to its stopping state, and
wherein the power supply is configured to supply electric power to the drive motor for rotating the mixing drum and to the brake for keeping the brake in its released state.

3. The truck mixer as claimed in claim 2, wherein the electric drive has an inverter which is configured to detect a fault case in the electric drive and, in a detected fault case, to set the brake to the stopping state.

4. The truck mixer as claimed in claim 3, wherein the inverter is configured to monitor at least one of the following state variables of the electric drive and to compare it with a desired state in order to detect the fault case:
an operating temperature,
a rotational speed, and
a direction of rotation.

5. The truck mixer as claimed in claim 3, wherein the electric drive has a first electrical energy source, which is configured for supplying the brake with electric power, and a second electrical energy source, which is configured for supplying the inverter for detecting fault cases.

6. The truck mixer as claimed in claim 5, wherein the truck mixer has an electric traction drive.

7. The truck mixer as claimed in claim 6, wherein the first electrical energy source is also configured for supplying the electric traction drive with electric power.

8. The truck mixer as claimed in claim 5, wherein the first electrical energy source is connected to the brake by a DC-to-DC voltage converter.

9. The truck mixer as claimed in claim 3, wherein the inverter is configured to monitor a state of the brake and to switch off the electric drive motor if the brake has changed to the stopping state.
